(19) United States
(12) Patent Application Publication
(10) Pub. No.: US 2017/0130926 A1
(43) Pub. Date: May 11, 2017

(54) Lighting Device for Vehicles

(71) Applicant: Hella KGaA Hueck & Co., Lippstadt (DE)

(72) Inventors: Matthias Kuge, Paderborn (DE); Johannes Quiring, Bad Sassendorf (DE)

(73) Assignee: Hella KGaA Hueck & Co., Lippstadt (DE)

(21) Appl. No.: 15/301,416

(22) PCT Filed: Apr. 1, 2015
(86) PCT No.: PCT/EP2015/057153

§ 371 Date: Oct. 3, 2016

(30) Foreign Application Priority Data
Apr. 10, 2014 (DE) 10 2014 105 099.1

(51) Int. Cl. F21S 8/10; F21V 29/76

(52) U.S. Cl. CPC F21S 48/1376; F21S 48/1109; F21S 48/155; F21S 48/1154; F21S 48/328; F21V 29/763

(57) ABSTRACT

A lighting device for vehicles having a light source mount for accommodating numerous light sources, and having a reflector. The reflector may be disposed in the main beam direction of the lighting device behind the light source mount in order to reflect a light bundle emitted by the numerous light sources toward the front. The light sources are disposed on a back surface of the light source mount in the main beam direction, and a cover element is disposed in the main beam direction in front of the light source mount which is provided with a labeling. At least a first light source is disposed on a first side of a central plane of the light source mount, and at least a second light source is disposed on a second side of the central plane of the light source mount. The reflector has a first reflector section on the first side of the central plane of the light source mount, and a second reflector section on the second side of the central plane of the light source mount. A blind is assigned to the at least one first light source and the at least one second light source, such that a light bundle emitted from the first light source strikes only the first reflector section and a light bundle emitted from the at least one second light source strikes only the second reflector section.

### CROSS REFERENCE

This application claims priority to PCT Patent Application No. PCT/EP2015/057153, filed 1 Apr. 2015, which itself claims priority to German Application No. 10 2014 105099.1, filed 10 Apr. 2014, the entirety of both of which are hereby incorporated by reference.

### FIELD OF THE INVENTION

The invention relates to a lighting device for vehicles, having a light source mount for accommodating numerous light sources, and having a reflector, which is disposed in the main beam direction of the lighting device, behind the light source mount, to reflect a light bundle emitted by the numerous light sources forwards in the main beam direction, wherein the light sources are disposed on a back surface of the light source mount in the main beam direction, and a cover element is disposed in the main beam direction in front of the light source mount, which is provided with a labeling.

### BACKGROUND OF THE INVENTION

A lighting device for vehicles is known from DE 103 11 072 B4, having a reflector and a light source mount with numerous light sources disposed in front of the reflector. The light sources are disposed on a back surface of the light source mount in the main beam direction of the lighting device, such that light bundles of the light sources strike the reflector counter to the main beam direction, from which they are reflected forwards in the main beam direction, in a manner corresponding to a predetermined light distribution. The light source mount is provided with a transparent cover element on a front surface disposed at the front in the main beam direction, which cover element has a labeling. Because the cover element is made of a transparent material, the labeling is backlit at a front surface of the cover element through the entry of beams reflected by means of the reflector. The light sources are disposed in rows, and project the light bundles onto the entire surface of the reflector. For certain uses, it is desirable for different sections of the reflector to be lit by different light sources.

### SUMMARY OF THE INVENTION

The object of the present invention is therefore to further develop a lighting device for vehicles, such that in an effective manner, different sections of a reflector reflect light bundles from different light sources, wherein the light sources are disposed in front of the reflector in the main beam direction of the lighting device.

A lighting device for vehicles is provided with a light source mount for accommodating numerous light sources, and a reflector, which is disposed in the main beam direction of the lighting device, behind the light source mount, for reflecting a light bundle emitted by the numerous light sources forwards in the main beam direction, wherein the light sources are disposed on a back surface of the light source mount in the main beam direction, and in that a cover element is disposed in front of the light source mount in the main beam direction, which is provided with a labeling, characterized in that,

at least one first light source is disposed on a first side of a central plane of the light source mount, and at least one second light source is disposed on a second side of the central plane of the light source mount,

the reflector has a first reflector section on the first side of the central plane of the light source mount, and a second reflector section on the second side of the central plane of the light source mount,

a blind is assigned to the at least one first light source and the at least one second light source such that a light bundle emitted from the first light source strikes only the first reflector section, and a light bundle emitted from the at least one second light source strikes only the second reflector section.

The particular advantage of the invention is that by means of a blind, a defined allocation of light bundles from different light sources to different reflector sections of a reflector is obtained. The reflector sections lie on opposite sides of a central plane of a light source mount supporting the light sources, or on both sides of a central plane of the reflector, respectively. A predefined light distribution can be generated, wherein diffused light from the light sources, which would not strike the assigned or allocated reflector section, but instead, would strike the adjacent reflector section, cannot contribute to the light distribution. The reflector sections can thus exhibit a design adapted to the demands. Both the blind as well as the light bearing element are covered toward the front by a cover element, wherein this cover element can be decorated for design purposes by means a labeling disposed on the cover element. By way of example, the labeling can be designed as a lettering or logo.

According to a preferred embodiment of the invention, at least one first light source disposed on a first side with respect to a central plane of the light source mount, and a second light source disposed on an opposite second side of the central plane of the light source mount, are disposed at a first spacing to the central plane, while the blind has a blind surface, on the opposing sides of which a first blind edge and a second blind edge are disposed, the respective spacing to the central plane of which is selected such that a first light bundle emitted from the first light source, and a second light bundle emitted from the second light source strike the first reflector section and the second reflector section respectively, wherein a light/dark border of the first light bundle, or the second light bundle, respectively, runs in the central plane of the reflector. As a result, it is ensured that the first reflector section and the second reflector section reflect the respective first light bundle or second light bundle assigned thereto.

According to a further development of the invention, the first blind edge and the second blind edge of the blind are disposed parallel to the central plane of the reflector and parallel to the central plane of the light source mount. The central plane of the reflector and the central plane of the light source mount run in a common plane, such that the lighting device exhibits a symmetrical construction.

According to a preferred embodiment of the invention, the light source mount has a heat dissipation plate, which lies flat against a mounting bracket. The mounting bracket preferably has a mounting lug, which engages with a hole in the reflector, and is attached to a cooling element disposed in the main beam direction behind the reflector. Advantageously, the heat generated by the light sources can be discharged by this means to a relatively large cooling element disposed in the back region.

According to a further development of the invention, the mounting bracket, the heat dissipating plate and the cooling element are made from a metallic material, such that a relatively quick heat dissipation is ensured.

According to a further development of the invention, the cover element is connected to the mounting bracket in a snap-in manner, and is composed of a non-transparent substance. The cover element can have a desired design, or lettering, or logos, respectively, without exerting a disruptive influence on the lighting function of the reflector as a result.

According to a further development of the invention, the mounting lug of the mounting bracket has a bore hole, such that a control circuitry for the light sources can be connected to the light source mount via an electric connecting line. Advantageously, the mounting lug of the mounting bracket can be used not only for heat dissipation, but also as a cable guide and for attaching the mounting bracket to the cooling element.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a horizontal section through a lighting device for vehicles.

FIG. 2 shows a section through the lighting device in accordance with the line II-II in FIG. 1.

FIG. 3 shows an enlarged depiction of a detail X in FIG. 2.

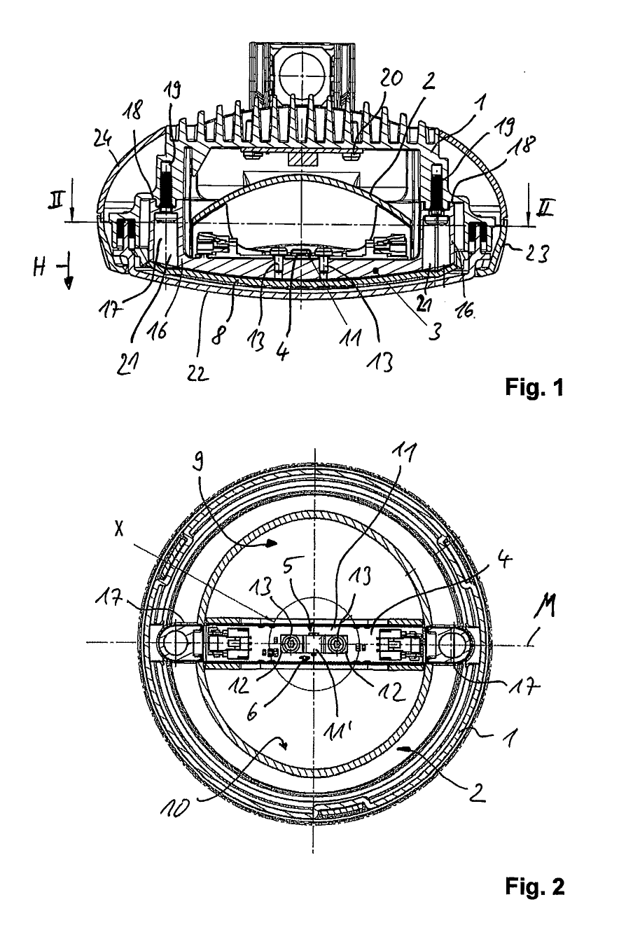

### DETAILED DESCRIPTION OF THE DRAWINGS

A lighting device for vehicles can be used, for example, as a headlamp for generating a high beam light distribution.

The lighting device has a supporting cooling element 1, onto which a reflector 2 is attached. A mounting bracket 3 is disposed in the main beam direction H in front of the reflector 2, on which a light source mount 4 is disposed on a back surface facing the reflector 2. The light source mount 4 is designed as a printed circuit board, having two LED light sources as the first light source 5, and a single LED light source as the second light source 6 on a back surface facing the reflector 2. The light source mount 4 is designed as a printed circuit board, and is positioned on the back surface of the mounting bracket 3 over a heat dissipation plate made of a metal material. The mounting bracket 3 and the light source mount 4 have a substantially elongated design. They form a strip that extends from one edge of the reflector 2 to an opposite edge thereof. A central plane M of the mounting bracket 3, or the light source mount 4, respectively, coincides with a central plane M of the reflector 2. An optical axis of the reflector 2 runs in the central plane M. The central plane M extends in a direction transverse to the extension plane of the mounting bracket 3 or the light source mount 4.

A cover element 8 adjoins a front surface of the mounting bracket 3 in the main beam direction H, which covers the front surface of the mounting bracket 3, and has a labeling, or a logo or lettering. The cover element 8 can be connected to the mounting bracket 3 by means of a snap-in mechanism.

The reflector 2 has a first reflector section 9, which interacts with the first light sources 5. Furthermore, the reflector 2 has a second reflector section 10, which interacts with the second light source 6. The reflector 2 has a circular front edge contour. The first reflector section 9 forms a first reflector half, while the second reflector section 10 forms a second reflector half.

A blind 11 is assigned to the light source mount 4 to ensure that only a light bundle (first light bundle) from the first light sources 5, and no diffused light from the second light source 6, strikes the first reflector section 9, or to ensure that only a light bundle (second light bundle) from the second light source 6, and no diffused light from the first light sources 5, strikes the second reflector section 10. The blind 11 has a hat-shaped cross section, and has attachment flanges 12 lying opposite one another, which are connected to the light source mount 4, or the mounting bracket 3, respectively, by means of screws 13.

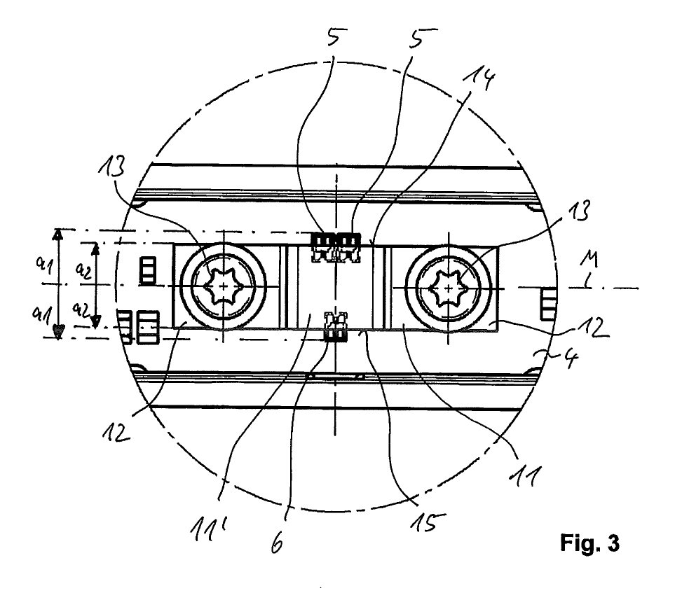

The blind 11 partially covers the light sources 5, 6 with a blind surface 11′ in a projection to a plane running perpendicular to the optical axis. As can be seen in FIG. 3, the light sources 5, 6 designed as LED chips are partially visible in the direction of projection. The first light sources 5 and the second light source 6 each exhibit an outer spacing a1 to the central plane M. The blind 11 has a first blind edge 14, partially covering the first light sources 5, and a second blind edge 15, partially covering the second light source 6, each of which exhibit a spacing a2 to the central plane M. The spacing a2 of the blind edges 14, 15 to the central plane M is smaller than the outer spacing a1 of the light sources 5, 6 to the central plane M. The spacing a2 of the blind edges 14, 15 to the central plane M is selected such that the light bundle emitted from the first light sources 5 strikes only the first reflector section 9, but not the second reflector section 10. The spacing a2 of the second blind edge to the central plan M, or the second blind edge 5, respectively, is selected such that a light bundle emitted from the second light source 6 strikes only the second reflector section 10, but not the first reflector section 9. The first blind edge 14 and the second blind edge 15 form a light/dark border of the respective light bundle striking the reflector 2, wherein the light/dark border runs along the central plane M.

The first blind edge 14 and the second blind edge 15 run parallel to one another, or parallel to the central plane M, respectively.

The first reflector section 9 and the second reflector section 10 each have sculpted surfaces as the reflection surfaces, such that the first light bundle and the second light bundle reflected thereon overlap to form a high beam light distribution.

In order to enable a heat dissipation form the light sources 5, 6 toward the cooling element 1, the mounting bracket 3 is made of a metallic pressure die-cast body (e.g. an aluminum pressure die-cast body) or a metallic extrusion molded body, which has opposing mounting lugs 16 extending from the extension plane of the mounting bracket 3, which engage in a penetration 17 in the reflector 2, and which bear on the cooling element 1 with an end edge 18. The mounting bracket 3 is connected to the cooling element 1 via fasteners in the form of screws 19. For this, the mounting lug 16 of the mounting bracket 3 has corresponding bore holes.

The cover element 8 is made from a non-transparent material, e.g. a plastic material.

The cooling element 1 has a control circuitry 20 on a front surface, for activating the light sources 5, 6. The control circuitry 20 is connected to the light source mount 5 via an electric connecting line. The electric connecting line runs through the penetration 17 in the reflector 2, or a bore hole 21 in the bracket 16. The electric connecting line is covered at the front of the mounting bracket 3 by the cover element 8.

In order to install the lighting device, the control circuitry 20 is first attached to a front surface of the cooling element 1. The electric connecting line connected to the control circuitry 20 is inserted through the penetrations 17 on both sides of the reflector 2, such that the reflector can then be connected to the cooling element 1. For this, the cooling element 1 has an adhesive bed, in which the supports of the reflector 2 engage, and are connected to the cooling element 1 in a material bonded manner. The light source mount 4, which has the heat dissipation plate, is attached to the back surface of the mounting bracket 3 by screws. The electrical connecting line establishes contact to the light source mount 4. Subsequently, the mounting bracket 3 is attached to the cooling element 1 by means of screws 19, after inserting the mounting lugs 16 on both sides through the penetration 17 in the reflector. Subsequently, the cover element 8 is attached to the front surface of the mounting bracket 3 by means of a snap-in mechanism. The end regions of the electrical connecting line run in a hollow space formed between the front surface of the mounting bracket 3 and the cover element 8. Subsequently, a lens 22 is placed in another adhesive bed in the cooling element 1, such that it is connected to the cooling element in a material bonded manner. Subsequently, a design ring 23 is placed on the reflector 2, and snapped in place therein. Subsequently, a housing 24 is placed thereon from the back, such that it can be snapped onto the design ring 23. The housing 24 is attached to the cooling element 1 via screws, not shown.

### LIST OF REFERENCE SYMBOLS

1 cooling element

2 reflector

3 mounting bracket

4 light source mount

5 first light source

6 second light source

8 cover element

9 first reflector section

10 second reflector section

11 blind

11′ blind surface

12 attachment flange

13 screws

14 first blind edge

15 second blind edge

16 mounting lug

17 penetration

18 end edge

19 screws

20 control circuitry

21 bore hole

22 lens

23 design ring

24 housing

H main beam direction

M central plane

a1, a2 spacing

1. A lighting device for vehicles comprising:
a light source mount for accommodating numerous light sources;
a reflector disposed in a main beam direction behind the light source mount for reflecting a light bundle emitted by the numerous light sources in the main beam direction, wherein the light sources are disposed on a back surface of the light source mount in the main beam direction;
a cover element disposed in the main beam direction in front of the light source mount, which is provided with a labeling,
wherein at least one first light source is disposed on a first side of a central plane (M) of the light source mount, and at least one second light source is disposed on a second side of the central plane (M) of the light source mount,
wherein the reflector has a first reflector section on the first side of the central plane (M) of the light source mount, and a second reflector section on the second side of the central plane (M) of the light source mount, and
wherein a blind is assigned to the at least one first light source and the at least one second light source, such that a light bundle emitted from the first light source strikes only the first reflector section and a light bundle emitted from the at least one second light source strikes only the second reflector section.

2. The lighting device according to claim 1, wherein the at least one first light source and the at least one second light source are disposed at a spacing to the central plane, and
wherein the blind has a blind surface having a first blind edge and having a second blind edge, each of which are disposed at a second spacing to the central plane (M) of the light source mount, that the light bundle emitted by the at least one first light source and the light bundle emitted by the at least one second light source strike the first reflector section or the second reflector section, respectively,
wherein a light/dark border of the two light bundles runs in a central plane (M) of the reflector.

3. The lighting device according to claim 2, wherein the first blind edge and the second blind edge run parallel to the central plane (M) of the reflector, or the light source mount.

4. The lighting device according to claim 1 wherein the light source mount has a heat dissipation plate, which bears against a mounting bracket over its surface.

5. The lighting device according to claim 4 wherein the mounting bracket has a mounting lug that engages in a penetration in the reflector, which is connected to a cooling element via attachment means, wherein the reflector is disposed between the cooling element and the mounting bracket.

6. The lighting device according to claim 5 wherein the mounting bracket and the cooling element are made of a metallic material.

7. The lighting device according to claim 4 wherein the mounting bracket has an elongated design, wherein the longitudinal central plane (M) of the mounting bracket coincides with the central plane (M) of the reflector.

8. The lighting device according to claim 1 wherein the first reflector section and the second reflector section each have sculpted surfaces for deflecting the light bundle emitted from the first light source or the light bundle reflected from the at least one second light source in a manner corresponding to a high beam light distribution.

9. The lighting device according to claim 1 wherein the cover element is connected in a snap-in manner, and in that the cover element is made of a non-transparent material.

10. The lighting device according to claim 5 wherein a control circuitry for the light sources is attached to the cooling element, and in that an electrical connecting line leads from the control circuitry to the light source mount via the penetration in the reflector and a bore hole in the mounting lug, wherein an end region of the electrical connecting line is disposed in a hollow space formed between a front side of the mounting bracket and the cover element.
